(19) United States
(12) Patent Application Publication
(10) Pub. No.: US 2019/0017175 A1
(43) Pub. Date: Jan. 17, 2019

(54) METHOD OF FORMING A METAL LAYER ON A PHOTOSENSITIVE RESIN

(71) Applicant: Microcosm Technology Co., Ltd, Tainan City (TW)

(72) Inventors: Tang -Chieh Huang, Tainan City (TW); Chao-Chin Chuang, Tainan City (TW); Chia-Fu Hsu, Tainan City (TW)

(21) Appl. No.: 16/020,901

(22) Filed: Jun. 27, 2018

(30) Foreign Application Priority Data
Jul. 14, 2017 (TW) 106123627

(51) Int. Cl. C23C 28/02; C23C 18/18; C23C 18/16; C25D 5/34; C08G 73/10

(52) U.S. Cl. CPC C23C 28/02; C23C 18/1893; C23C 18/1641; C08G 73/10; C23C 18/1692; C23C 18/1868; C25D 5/34; C23C 18/1653

(57) ABSTRACT

The present invention provides a method of forming a metal layer on a specific photosensitive resin. The method comprises the following steps: (i) pretreatment: cleaning and pre-activating a surface of the photosensitive resin by using an alkaline solution; (ii) surface modification: soaking the photosensitive resin in a surface modifier to form an organic modification layer; (iii) surface activation: adding catalytic metal ions to form a metal ion complex with the organic modification layer; (iv) reduction reaction: reducing the metal ion complex into a nano metal catalyst by using a reducing agent; (v) chemical plating: soaking the photosensitive resin in an chemical plating solution to form a conductive metal layer; (vi) heat treatment: baking the photosensitive resin at 100-250° C., and (vii) electroplating thickening: electroplating the baked photosensitive resin to thicken the conductive metal layer.

### BACKGROUND OF THE INVENTION

### Field of the Invention

The present invention relates to a method of forming a metal layer on a photosensitive resin, and particularly to a method for metallizing a surface of a specific photosensitive polyimide resin to form a metal layer.

### Description of the Prior Art

Polyimide is a common substrate material for flexible printed circuit board and IC packaging industries. It is an organic material that has flexibility, solvent resistance (chemical resistance), high temperature resistance, and non-conductivity. With the trend toward thinner and more versatile electronic products, the high wiring density and via hole miniaturization have become basic requirements for flexible printed circuit boards. However, general non-photosensitive polyimides have good chemical resistance, so it is not easy to produce planar and vertical conductor trenches by chemical etching, and it is often necessary to conduct the processing of micro-via holes through laser drilling or dry via-etching with photoresist, and then the activation by chemical treatment to form a metal layer. This process is more complex. However, even if a metal layer can be formed on the non-photosensitive polyimide, the bonding strength between the metal layer and the polyimide is not high enough, and will be broken easily by the high temperature baking and pressing process when manufacturing the multilayer board.

The photosensitive polyimide is different from the traditional polyimide, and has the processing characteristics of photosensitized hole formation without additional use of the laser drilling or dry via-etching with photoresist for the production of vertical conductive units. However, no practical method exists that can form a metal layer with high bonding strength on a photosensitive polyimide resin.

### SUMMARY OF THE INVENTION

The present invention provides a method of forming a metal layer on a specific photosensitive resin, which comprises a pretreatment step, a wet chemical surface modification step, and a metallization step. The method can be applied to a specific photosensitive polyimide resin, and being combined with the photosensitized hole forming property, the metal wire manufacturing process for the multilayer integrated vertical conductive unit can be made more streamlined.

According to the present invention, a method of forming a metal layer on a photosensitive resin is provided. The photosensitive resin comprises (a) an epoxy compound, (b) a photosensitive polyimide, and (c) a photoinitiator. The epoxy compound accounts for 5-40% of the solid weight of the photosensitive resin. The photosensitive polyimide has the structure of formula (1):

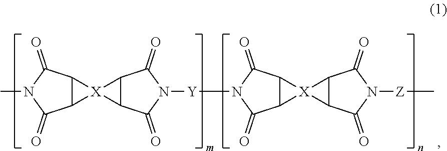

wherein m and n are each independently 1 to 600; X is a tetravalent organic group, whose main chain moiety contains an alicyclic group; Y is a divalent organic group, whose main chain moiety contains a siloxane group; Z is a divalent organic group, whose branched moiety contains at least a phenoilc group or a carboxyl group; the photosensitive polyimide accounts for 30-90% of the solid weight of the photosensitive resin; and the photoinitiator accounts for 0.1-15% of the solid weight of the photosensitive resin.

The method of forming a metal layer on a photosensitive resin comprises the following steps:

(i) pretreatment: cleaning and pre-activating a surface of the photosensitive resin by using an alkaline solution;

(ii) surface modification: soaking the photosensitive resin in a surface modifier to form an organic modification layer on the photosensitive resin, wherein the surface modifier is an aqueous solution of at least one amino compound selected from formulas (2)-(6):

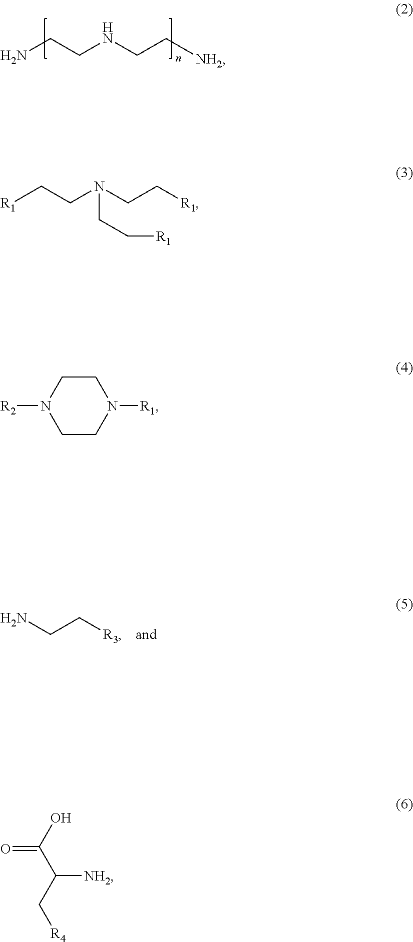

wherein n=1-3, R₁ is NH₂, NHCH₃ or NH(CH3)₂, R₂ is H or CₘH₂ₘNH₂, m=1-3, R₃ is NH₂ SH or OH, and R₄ is SH,

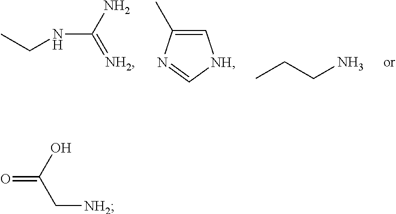

(iii) surface activation: adding catalytic metal ions to form a metal ion complex with the organic modification layer on the photosensitive resin;

(iv) reduction reaction: reducing the metal ion complex adhered to the photosensitive resin into a nano metal catalyst by using a reducing agent;

(v) chemical plating: soaking the photosensitive resin formed with the nano metal catalyst in a chemical plating solution to form a conductive metal layer;

(vi) heat treatment: baking the photosensitive resin formed with the conductive metal layer at 100-250° C., and

(vii) electroplating thickening: electroplating the baked photosensitive resin to thicken the conductive metal layer.

In an embodiment, in the surface modification step (ii), the soaking time is 1-20 minutes, the concentration of the amino compound in the surface modifier is 0.1-10 g/L, and the temperature is 30-75° C.

In an embodiment, the catalytic metal ions added in the surface activation step (iii) is an acidic aqueous solution containing Cu, Ni, Ag, Au, or Pd ions.

In an embodiment, the reducing agent used in the reduction reaction step (iv) is sodium hypophosphite, sodium borohydride, dimethylamine borane or hydrazine aqueous solution

In an embodiment, the chemical plating solution used in the chemical plating step (v) comprises copper ions, nickel ions, a chelating agent, a reducing agent, a pH buffer, a surfactant, and a pH adjuster.

In an embodiment, the source of the copper ions in the chemical plating solution is copper nitrate, copper sulfate, copper chloride, or copper sulfamate.

In an embodiment, the source of the nickel ions in the chemical plating solution is nickel sulfate, nickel nitrate, nickel chloride, nickel sulfate, or nickel sulfamate.

In an embodiment, the chelating agent in the chemical plating solution is sodium citrate, potassium sodium tartrate, or ethylene diamine tetraacetic acid.

In an embodiment, the thickness of the conductive metal layer formed in the chemical plating step (v) is 50-200 nm.

In an embodiment, the baking time of the heat treatment step (vi) is 10-60 minutes.

In an embodiment, the pretreatment step (i) further comprises cleaning and pre-activating the surface of the photosensitive resin by using parallel ultraviolet light or plasma.

In an embodiment, when the pretreatment step (i) is carried out by using parallel ultraviolet light, the irradiation wavelength of the parallel ultraviolet light is 100-280 nm, the cumulative irradiation intensity on the surface is 1-20 J/cm², and the irradiation time is 1-30 minutes.

In an embodiment, when the pretreatment step (i) is carried out by using plasma, the output power is 100-5000 W, and the treatment time is 0.5-30 minutes.

In an embodiment, the electroplating thickening step (vii) increases the thickness of the conductive metal layer to 12-18 μm.

The foregoing and other aspects of the present invention will become more apparent from the following embodiments in conjunction with the written description.

### DETAILED DESCRIPTION OF THE EMBODIMENTS

The method of forming a metal layer on a photosensitive resin according to the present invention includes the following steps:

(i) surface treatment (pretreatment)

(ii) surface ring opening (modification)

(iii) adsorption of catalyst particles (surface activation)

(iv) reduction of catalyst particles

(v) chemical plating (electroless plating)

(vi) heat treatment

(vii) electroplating

(viii) removing water and air-drying

In the present invention, the photosensitive resin having a metal layer formed thereon as a substrate is mainly composed of photosensitive polyimide. The components of the photosensitive resin include (a) an epoxy compound, (b) a photosensitive polyimide, and (c) a photoinitiator. The photosensitive polyimide has the structure of formula (1):

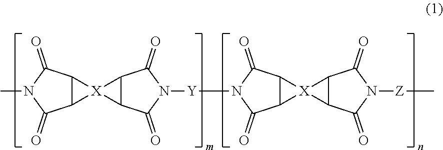

wherein m and n are each independently 1 to 600; X is a tetravalent organic group, whose main chain moiety contains an alicyclic group, preferably an alicyclic group without a benzene ring, including but not limited to

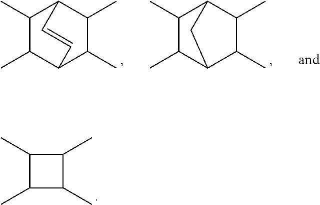

Y is a divalent organic group, whose main chain moiety contains a siloxane group, such as the following formula:

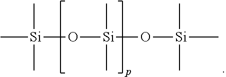

The chain length of Y is preferably short (p=0), and the longest chain length of Y may be p=20. If the chain length is too long, the nature of the photosensitive polyimide will be destroyed. Z is a divalent organic group, whose side chain moiety contains at least a phenolic group or a carboxyl group. The content of the phenolic group or the carboxyl group approximately accounts for 5 to 30% of the number of moles of the photosensitive polyimide. The development time may be controlled by adjusting the molar ratio of the branched phenolic group or the carboxyl group. When the content of the branched phenolic group or carboxyl group is high, the alkaline developer is preferred for the solubility of the photosensitive polyimide and may improve the developability. Z may include, but not be limited to, the following groups:

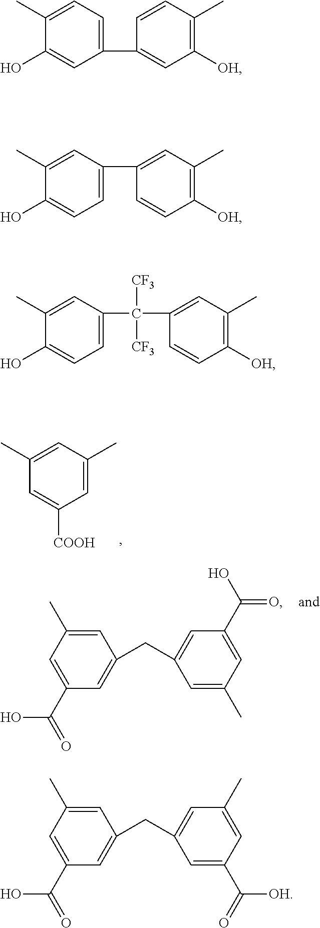

The photosensitive polyimide accounts for 30-90% of the solid weight of the photosensitive resin; the epoxy compound accounts for 5-40% of the solid weight of the photosensitive resin; and the photoinitiator accounts for 0.1-15% of the solid weight of the photosensitive resin. Since such kind of photosensitive polyimide has siloxane groups, imide ring groups, carboxyl groups, etc. on the surface, it is easier to carry out the coupling reaction with the amino group of the surface modifier used in the present invention.

(i) Surface Treatment (Pretreatment)

First, the surface of the photosensitive resin substrate is cleaned and pre-activated. The methods used include irradiation with parallel ultraviolet light, plasma, and soaking with alkaline aqueous solutions, either one of which or a combination thereof may be used. When parallel ultraviolet light is used for pretreatment, the parallel ultraviolet light has an irradiation wavelength of 100-280 nm, the cumulative irradiation intensity on the surface is 1-20 J/cm², and the irradiation time is 1-30 minutes. When the plasma is used for the pretreatment, the output power is 100-5000 W and the treatment time is 0.5-30 minutes. In this embodiment, the photosensitive resin substrate is irradiated by parallel ultraviolet light for 10 minutes, soaked in 5M KOH aqueous solution at 40° C. for several minutes, and then taken out. The purpose of soaking in the alkaline aqueous solution is to open the ring of the carbonyl group (C═O) on the surface of the photosensitive resin of the formula (1) in order to form an organic modification layer containing a large amount of a carboxyl group (COOH). Subsequently, the photosensitive resin substrate is rinsed with deionized water to remove the alkaline solution or other organics remaining on the surface.

(ii) Surface Modification

Next, the photosensitive resin is soaked in the surface modifier to further modify the carboxyl (COOH) and hydroxyl (OH) functional groups on the surface of the photosensitive resin. The surface modifier may be an aqueous solution containing at least one amino compound selected from the following formulas (2) to (6) below, and the concentration of the amino compound is between 0.1 and 10 g/L:

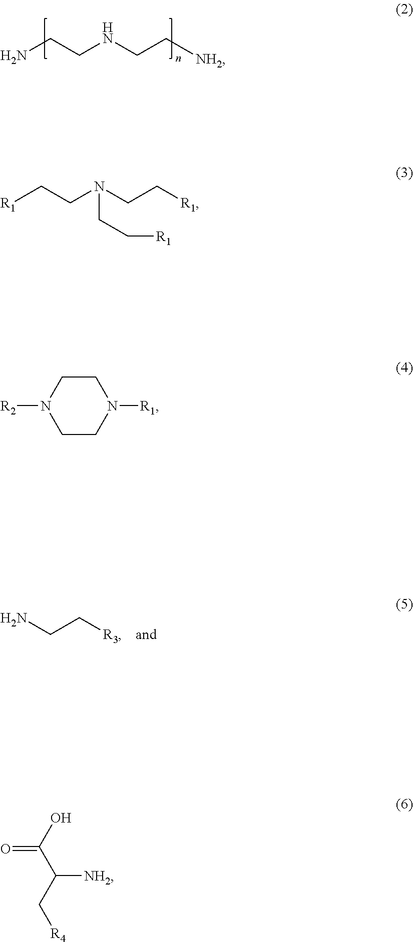

wherein n=1-3, R₁ is NH₂, NHCH₃ or NH(CH3)₂, R₂ is H or CₘH₂ₘNH₂, m is 1-3, R₃ is NH₂, SH or OH, R₄ is SH,

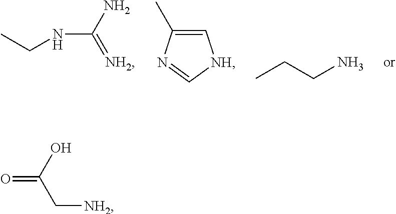

the temperature of the modification reaction is 30-75° C. (preferably 50° C.), and the soaking time is 1-20 minutes. The surface modifier can be coupled with the organic groups on the surface of the photosensitive resin, such as the siloxane groups, the imide ring groups, or the carboxyl groups.

(iii) Surface Activation

Next, the photosensitive resin substrate is soaked in an activation liquid, for example, an aqueous solution containing palladium ions, which contains 0.4 g/L of palladium chloride and 0.4 g/L of ammonium chloride at 30° C. for 2 minutes. The metal ions in the activation liquid will form complexes with the organic modification layer. In other embodiments, an acidic aqueous solution containing other metal ions, such as Cu, Ni, Ag, or Au, may also be used as the activation liquid.

(iv) Reduction Reaction

Subsequently, the photosensitive resin substrate activated in step (iii) above is soaked in an aqueous solution containing a reducing agent for performing the reduction reaction of palladium ions. The composition of the reducing solution contains 28.6 g/L sodium hypophosphite and deionized water. The processing temperature is 30° C., and the soaking time is 2 minutes. Other types of reducing agents such as sodium borohydride, dimethylamine borane or hydrazine aqueous solution can also be used.

(v) Chemical Plating

On the surface of the current photosensitive resin substrate, palladium metal produced after catalytic ion reduction has existed. Next, electroless plating is performed to deposit nano metal particles on the surface of the photosensitive polyimide substrate and form a metal conductive layer (film), which has a deposition thickness of 50 to 200 nm. The electroless plating solution is preferably an electroless plating solution free of formaldehyde and formulated as an aqueous solution having a pH of 9 and an operating temperature of 50° C.

In one embodiment, the chemical plating solution preferably comprises copper ions, nickel ions, a chelating agent, a reducing agent, a pH buffer, a surfactant, and a pH adjuster. The source of the copper ions is copper nitrate, copper sulfate, copper chloride, or copper sulfamate; the source of nickel ions is nickel sulfate, nickel nitrate, nickel chloride, nickel sulfate, or nickel sulfamate; and the chelating agent is sodium citrate, potassium sodium tartrate, or ethylene diamine tetraacetic acid.

(vi) Heat Treatment

Next, the cross-linking reaction between the surface of the photosensitive resin substrate and the metal conductive layer is facilitated through heat treatment, which further improves the adhesion force between the surface of the photosensitive resin substrate and the metal conductive layer. In this embodiment, the operating temperature range of the heat treatment is 150° C., and the reaction time is 60 minutes. However, the time and temperature can be adjusted as required.

(vii) Electroplating

At last, a copper electroplating solution containing the chemical additive is used to perform electroplating thickening, which thickens the metal conductive layer to a plating thickness of 18 μm. The composition of the copper electroplating solution used is as follows:

CuSO_{4.5}H₂O: 100 g/L

H₂SO₄: 127.4 g/L

PEG8000 (Polyethylene glycol): 0.2 g/L

SPS (Sodium dithiopropanesulfonate): 0.004 g/L

After being processed by the steps of the above embodiments, the metal layer formed on the photosensitive resin has a tear strength of 0.7 kgf/cm. After being placed at a temperature of 150° C. for 168 hours, the tear strength can still be maintained at 0.6 kgf/cm. On the contrary, the metal layer as formed without surface modification (step ii was omitted) has a tear strength of only about 0.2 kgf/cm, which demonstrates that the method of the present invention can increase the tear strength of the metal layer by 3 times or more.

In addition, in the process for producing general multi-layer circuit boards, after each metal layer is completed, it needs to undergo the cyclic baking and pressing process, which presses the buildup polymer and metal layers through a plurality of high-temperature and high-pressure processes, so as to increase the adhesion between the heterogeneous material layers. However, in the conventional method of forming a metal layer on a polyimide/photosensitive polyimide, the metal layer as formed undergoes a cyclic baking and pressing treatment, resulting in substantial reduce of tear strength of the metal layer (less than 1/10). Nevertheless, in the present invention, the metal layer formed on the photosensitive resin can maintain a tear strength of about 0.5 kgf/cm after repeated cycles of baking and pressing at a high temperature of 185° C. and a high pressure of 24.5 kgf/cm, and thus can be used in the production of multilayer boards.

In summary, according to the steps of the present invention, the metal layer formed on the photosensitive resin not only has a higher tear strength, but also can be applied to the layer buildup process for the multilayer flexible printed circuit boards and the multilayer HDI printed circuit boards as well as the semi-additive process for IC carrier plates. In addition, the method of the present invention is relatively simple compared to the conventional wet-metallization and layer buildup processes for non-photosensitive resins and other non-photosensitive polymers. Traditionally, all non-photosensitive resins rely on the processing methods of dry etching, laser drilling and mechanical drilling, followed by the processing procedures of slag removal/photoresist removal, neutralizing treatment, roughening, and metallization processes. The photosensitive resin used in the present invention can be molded by ultraviolet light irradiation without slag generation. Therefore, the procedures of slag removal and neutralization treatment can be eliminated, which effectively saves the cost of the processes, reduces the failure rate of multi-channel treatment, and increases the production rate.

While the present invention is illustrated above by the embodiments, these embodiments are not intended to limit the invention. Equivalent implementations or alterations may be made to these embodiments by those skilled in the art without departing from the spirit of the art of the invention, and the scope of the present invention should be defined by the appended claims.

What is claimed is:

1. A method of forming a metal layer on a photosensitive resin, the photosensitive resin containing (a) an epoxy compound, (b) a photosensitive polyimide, and (c) a photoinitiator; the epoxy compound accounting for 5-40% of the solid weight of the photosensitive resin; the photosensitive polyimide having a structure of formula (1): 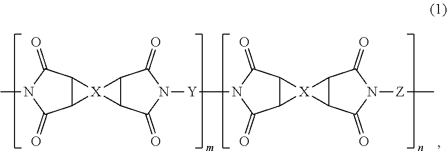
wherein m and n are each independently 1 to 600; X is a tetravalent organic group, whose main chain moiety contains an alicyclic group; Y is a divalent organic group, whose main chain moiety contains a siloxane group; Z is a divalent organic group, whose branched moiety contains at least a phenoilc group or a carboxyl group; the photosensitive polyimide accounts for 30-90% of the solid weight of the photosensitive resin; and the photoinitiator accounts for 0.1-15% of the solid weight of the photosensitive resin; the method comprising the following steps:
(i) pretreatment: cleaning and pre-activating a surface of the photosensitive resin by using an alkaline solution, and by using parallel ultraviolet light or plasma;
(ii) surface modification: soaking the photosensitive resin in a surface modifier to form an organic modification layer on the photosensitive resin, wherein the surface modifier is an aqueous solution of at least one amino compound selected from formulas (2)-(6): 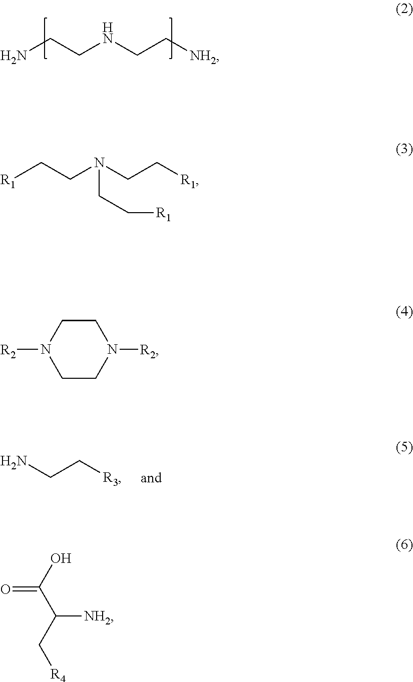
wherein n=1-3, R₁ is NH₂, NHCH₃ or NH(CH3)₂, R₂ is H or CₘH₂ₘNH₂, m=1-3, R₃ is NH₂, SH or OH, R₄ is SH, 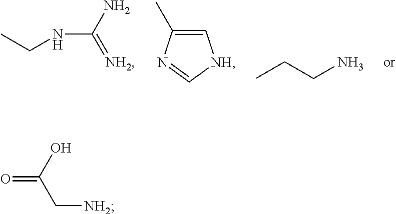
(iii) surface activation: adding catalytic metal ions to form a metal ion complex with the organic modification layer on the photosensitive resin;
(iv) reduction reaction: reducing the metal ion complex adhered to the photosensitive resin into a nano metal catalyst by using a reducing agent;
(v) chemical plating: soaking the photosensitive resin formed with the nano metal catalyst in a chemical plating solution to form a conductive metal layer;
(vi) heat treatment: baking the photosensitive resin formed with the conductive metal layer at 100-250° C., and
(vii) electroplating thickening: electroplating the baked photosensitive resin to thicken the conductive metal layer.

2. The method of claim 1, wherein in the surface modification step (ii), the soaking time is 1-20 minutes, the concentration of the amino compound in the surface modifier is 0.1-10 g/L, and the temperature is 30-75° C.

3. The method of claim 1, wherein the catalytic metal ions added in the surface activation step (iii) is an acidic aqueous solution containing Cu, Ni, Ag, Au, or Pd ions.

4. The method of claim 1, wherein the reducing agent used in the reduction reaction step (iv) is sodium hypophosphite, sodium borohydride, dimethylamine borane or hydrazine aqueous solution.

5. The method of claim 1, wherein the chemical plating solution used in the chemical plating step (v) comprises copper ions, nickel ions, a chelating agent, a reducing agent, a pH buffer, a surfactant, and a pH adjuster.

6. The method of claim 5, wherein the source of the copper ions is copper nitrate, copper sulfate, copper chloride, or copper sulfamate.

7. The method of claim 5, wherein the source of the nickel ions is nickel sulfate, nickel nitrate, nickel chloride, nickel sulfate, or nickel sulfamate.

8. The method of claim 5, wherein the chelating agent is sodium citrate, potassium sodium tartrate, or ethylene diamine tetraacetic acid.

9. The method of claim 1, wherein the thickness of the conductive metal layer formed in the chemical plating step (v) is 50-200 nm.

10. The method of claim 1, wherein the baking time of the heat treatment step (vi) is 10-60 minutes.

11. The method of claim 1, wherein when the pretreatment is carried out by using parallel ultraviolet light, the irradiation wavelength of the parallel ultraviolet light is 100-280 nm, the cumulative irradiation intensity on the surface is 1-20 J/cm², and the irradiation time is 1-30 minutes.

12. The method of claim 1, wherein when the pretreatment is carried out by using plasma, the output power is 100-5000 W, and the treatment time is 0.5-30 minutes.

13. The method of claim 1, wherein in the electroplating thickening step (vii), the thickness of the conductive metal layer is increased to 12-18 μm.
